(19) United States
(12) Patent Application Publication
(10) Pub. No.: US 2019/0179562 A1
(43) Pub. Date: Jun. 13, 2019

(54) MEMORY SYSTEM AND OPERATING METHOD THEREOF

(71) Applicant: SK hynix Inc., Gyeonggi-do (KR)

(72) Inventor: Eu-Joon BYUN, Gyeonggi-do (KR)

(21) Appl. No.: 15/968,341

(22) Filed: May 1, 2018

(30) Foreign Application Priority Data
Dec. 13, 2017 (KR) 10-2017-0171018

(51) Int. Cl. G06F 3/06

(52) U.S. Cl. CPC G06F 3/0652; G06F 3/0673; G06F 3/0619

(57) ABSTRACT

A memory system includes: a memory device suitable for storing indexes corresponding to a plurality of pages included in at least one memory block; a controller including: detection unit suitable for detecting an index corresponding to a page, to which an abnormal program operation is performed, in a page group; a region setting unit suitable for setting a valid page region of the page group based on the detected index; and a processor suitable for controlling the memory device to flush the index along with map data corresponding to data, which is stored in the page group, at each predetermined period, wherein the page group includes a plurality of pages, in which data corresponding to the map data is stored until the map data is flushed.

### CROSS-REFERENCE TO RELATED APPLICATIONS

The present application claims priority under 35 U.S.C. § 119(a) to Korean Patent Application No. 10-2017-0171018, filed on Dec. 13, 2017, the disclosure of which is incorporated herein by reference in its entirety.

### BACKGROUND

### 1. Field

Various exemplary embodiments of the present invention generally relate to an electronic device. Particularly, the embodiments relate to a memory system capable of processing data efficiently and an operating method thereof.

### 2. Description of the Related Art

The computer environment paradigm has changed to ubiquitous computing systems that can be used anytime and anywhere. That is, use of portable electronic devices such as mobile phones, digital cameras, and notebook computers has rapidly increased. These portable electronic devices generally use a memory system having one or more memory devices for storing data. A memory system may be used as a main memory device or an auxiliary memory device of a portable electronic device.

Memory systems provide excellent stability, durability, high information access speed, and low power consumption because they have no moving parts. Examples of memory systems having such advantages include universal serial bus (USB) memory devices, memory cards having various interfaces, and solid state drives (SSD).

### SUMMARY

Various embodiments are directed to a memory system capable of improving performance of a memory system and an operating method thereof.

In accordance with an embodiment of the present invention, a memory system may include a memory device suitable for storing indexes corresponding to a plurality of pages included in at least one memory block; a controller including: a detection unit suitable for detecting an index corresponding to a page, to which an abnormal program operation is performed, in a page group; a region setting unit suitable for setting a valid page region of the page group based on the detected index; and a processor suitable for controlling the memory device to flush the index along with map data corresponding to data, which is stored in the page group, at each predetermined period, wherein the page group includes a plurality of pages, in which data corresponding to the map data is stored until the map data is flushed.

In accordance with an embodiment of the present invention, an operating method of a memory system, the method may include detecting an index corresponding to a page, to which an abnormal program operation is performed, in a page group of a memory device; setting a valid page region of the page group based on the index; and controlling the memory device to flush the index along with map data corresponding to data, which is stored in the page group, at each predetermined period, wherein the indexes correspond to a plurality of pages included in each of memory blocks, and wherein the page group includes a plurality of pages, in which data corresponding to the map data is stored until the map data is flushed.

In accordance with an embodiment of the present invention, a memory system may include a memory device suitable for storing indexes corresponding to a plurality of pages included in each of a plurality of memory blocks; and a controller suitable for controlling the memory device to flush map data corresponding to data which is stored in a page group periodically at a predetermined period, a detection unit is suitable for detecting a page and an index for the page in the page group to which an abnormal program operation is performed; and a region setting unit suitable for defining the page group into a valid page region and an uncorrectable error correction code UECC region based on the detected page index.

These and other features and advantages of the present invention will become apparent to those with ordinary skill in the art to which the present invention belongs from the following description in conjunction with the accompanying drawings.

### BRIEF DESCRIPTION OF THE DRAWINGS

FIG. 1 is a block diagram illustrating a data processing system including a memory system, in accordance with an embodiment of the present invention.

FIG. 2 is a schematic diagram illustrating an exemplary configuration of a memory device employed in the memory system shown in FIG. 1.

FIG. 3 is a circuit diagram illustrating an exemplary configuration of a memory cell array of a memory block in the memory device shown in FIG. 2.

FIG. 4 is a schematic diagram illustrating an exemplary three-dimensional structure of the memory device shown in FIG. 2.

FIG. 5 is a schematic diagram illustrating an exemplary configuration of the memory system, in accordance with an embodiment of the present invention.

FIG. 6 is a schematic diagram illustrating a memory block according to an operation of the memory system, in accordance with an embodiment of the present invention.

FIG. 7 is a schematic diagram illustrating a memory block according to an operation of the memory system, in accordance with an embodiment of the present invention.

FIGS. 8 to 16 are diagrams schematically illustrating application examples of a data processing system, in accordance with various embodiments of the present invention.

### DETAILED DESCRIPTION

Various embodiments of the present invention are described below in more detail with reference to the accompanying drawings. We note, however, that the present invention may be embodied in different other embodiments, forms and variations thereof and should not be construed as being limited to the embodiments set forth herein. Rather, the described embodiments are provided so that this disclosure will be thorough and complete, and will fully convey the present invention to those skilled in the art to which this invention pertains. Throughout the disclosure, like reference numerals refer to like parts throughout the various figures and embodiments of the present invention.

It will be understood that, although the terms “first”, “second”, “third”, and so on may be used herein to describe various elements, these elements are not limited by these terms. These terms are used to distinguish one element from another element. Thus, a first element described below could also be termed as a second or third element without departing from the spirit and scope of the present invention.

The drawings are not necessarily to scale and, in some instances, proportions may have been exaggerated in order to clearly illustrate features of the embodiments. When an element is referred to as being connected or coupled to another element, it should be understood that the former can be directly connected or coupled to the latter, or electrically connected or coupled to the latter via an intervening element therebetween.

It will be further understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present.

The terminology used herein is for the purpose of describing particular embodiments only and is not intended to be limiting of the present invention.

As used herein, singular forms are intended to include the plural forms as well, unless the context clearly indicates otherwise.

It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art to which the present invention belongs in view of the present disclosure. It will be further understood that terms, such as those defined in commonly used dictionaries, should be interpreted as having a meaning that is consistent with their meaning in the context of the present disclosure and the relevant art and will not be interpreted in an idealized or overly formal sense unless expressly so defined herein.

In the following description, numerous specific details are set forth in order to provide a thorough understanding of the present invention. The present invention may be practiced without some or all of these specific details. In other instances, well-known process structures and/or processes have not been described in detail in order not to unnecessarily obscure the present invention.

It is also noted, that in some instances, as would be apparent to those skilled in the relevant art, a feature or element described in connection with one embodiment may be used singly or in combination with other features or elements of another embodiment, unless otherwise specifically indicated.

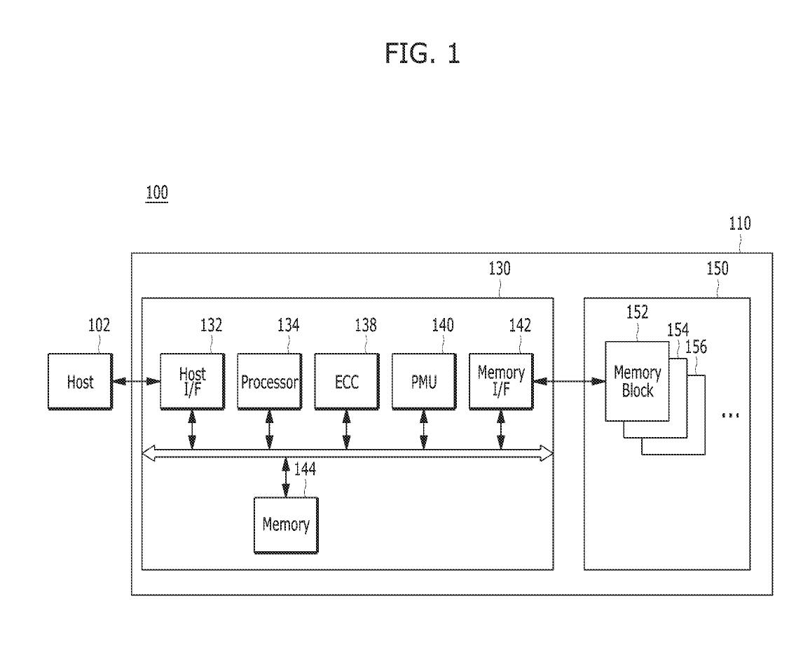

FIG. 1 is a block diagram illustrating a data processing system 100, in accordance with an embodiment of the present invention.

Referring to FIG. 1, the data processing system 100 may include a host 102 operatively coupled to a memory system 110.

The host 102 may include, for example, a portable electronic device such as a mobile phone, an MP3 player, and a laptop computer or an electronic device such as a desktop computer, a game player, a TV, a projector, and the like.

The memory system 110 may operate in response to a request from the host 102, and in particular, store data to be accessed by the host 102. The memory system 110 may be used as a main memory system or an auxiliary memory system of the host 102. The memory system 110 may be implemented with any one of various types of storage devices, which may be electrically coupled with the host 102, according to a protocol of a host interface. Examples of suitable storage devices include a solid state drive (SSD), a multimedia card (MMC), an embedded MMC (eMMC), a reduced size MMC (RS-MMC) and a micro-MMC, a secure digital (SD) card, a mini-SD and a micro-SD, a universal serial bus (USB) storage device, a universal flash storage (UFS) device, a compact flash (CF) card, a smart media (SM) card, a memory stick, and the like.

The storage devices for the memory system 110 may be implemented with a volatile memory device such as a dynamic random access memory (DRAM) and a static RAM (SRAM) and nonvolatile memory device such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), resistive RAM (RRAM) and a flash memory.

The memory system 110 may include a memory device 150 which stores data to be accessed by the host 102, and a controller 130 which may control storage of data in the memory device 150.

The controller 130 and the memory device 150 may be integrated into a single semiconductor device, which may be included in the various types of memory systems as exemplified above.

The memory system 110 may be configured as part of a computer, an ultra-mobile PC (UMPC), a workstation, a net-book, a personal digital assistant (PDA), a portable computer, a web tablet, a tablet computer, a wireless phone, a mobile phone, a smart phone, an e-book, a portable multimedia player (PMP), a portable game player, a navigation system, a black box, a digital camera, a digital multimedia broadcasting (DMB) player, a 3D television, a smart television, a digital audio recorder, a digital audio player, a digital picture recorder, a digital picture player, a digital video recorder, a digital video player, a storage configuring a data center, a device capable of transmitting and receiving information under a wireless environment, one of various electronic devices configuring a home network, one of various electronic devices configuring a computer network, one of various electronic devices configuring a telematics network, a radio frequency identification (RFID) device, or one of various component elements configuring a computing system.

The memory device 150 may be a nonvolatile memory device and may retain data stored therein even though power is not supplied. The memory device 150 may store data provided from the host 102 through a write operation, and provide data stored therein to the host 102 through a read operation. The memory device 150 may include a plurality of memory blocks 152 to 156, each of the memory blocks 152 to 156 may include a plurality of pages. Each of the pages may include a plurality of memory cells to which a plurality of word lines WL are electrically coupled.

The controller 130 may control overall operations of the memory device 150, such as read, write, program, and erase operations. For example, the controller 130 of the memory system 110 may control the memory device 150 in response to a request from the host 102. The controller 130 may provide the data read from the memory device 150, to the host 102, and/or may store the data provided from the host 102 into the memory device 150.

The controller 130 may include a host interface (I/F) unit 132, a processor 134, an error correction code (ECC) unit 138, a power management unit (PMU) 140, a memory interface I/F unit 142 such as a NAND flash controller (NFC), and a memory 144 all operatively coupled via an internal bus.

The host interface unit 132 may process commands and data provided from the host 102, and may communicate with the host 102 through at least one of various interface protocols such as universal serial bus (USB), multimedia card (MMC), peripheral component interconnect-express (PCI-E), small computer system interface (SCSI), serial-attached SCSI (SAS), serial advanced technology attachment (SATA), parallel advanced technology attachment (PATA), small computer system interface (SCSI), enhanced small disk interface (ESDI) and integrated drive electronics (IDE).

The ECC unit 138 may detect and correct errors in the data read from the memory device 150 during the read operation. The ECC unit 138 may not correct error bits when the number of the error bits is greater than or equal to a threshold number of correctable error bits, and may output an error correction fail signal indicating failure in correcting the error bits.

The ECC unit 138 may perform an error correction operation based on a coded modulation such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), a Block coded modulation (BCM), and so on. The ECC unit 138 may include all circuits, modules, systems, or devices for the error correction operation.

The PMU 140 may provide and manage power of the controller 130.

The memory interface unit 142 may serve as a memory/storage interface between the controller 130 and the memory device 150 to allow the controller 130 to control the memory device 150 in response to a request from the host 102. The memory interface unit 142 may generate a control signal for the memory device 150 and process data to be provided to the memory device 150 under the control of the processor 134 when the memory device 150 is a flash memory and, in particular, when the memory device 150 is a NAND flash memory. It is noted that the present invention is not limited to NAND flash memory/NAND flash interface, and that a suitable memory/storage interface may be selected depending upon the type of the memory device 150.

The memory 144 may serve as a working memory of the memory system 110 and the controller 130, and store data for driving the memory system 110 and the controller 130. The controller 130 may control the memory device 150 in response to a request from the host 102. The controller 130 may provide data read from the memory device 150 to the host 102, may store data provided from the host 102 into the memory device 150. The memory 144 may store data required for the controller 130 and the memory device 150 to perform these operations.

The memory 144 may be implemented with a volatile memory. The memory 144 may be implemented with a static random access memory (SRAM) or a dynamic random access memory (DRAM). Although FIG. 1 shows the memory 144 inside controller 130, it is for illustrative purposes only, and the present disclosure is not limited thereto. That is, the memory 144 may be disposed within or out of the controller 130. In another embodiment, the memory 144 may be embodied by an external volatile memory having a memory interface transferring data between the memory 144 and the controller 130.

The processor 134 may control the overall operations of the memory system 110. The processor 134 may drive firmware, which is referred to as a flash translation layer (FTL), to control the general operations of the memory system 110.

The FTL may perform an operation as an interface between the host 102 and the memory device 150. The host 102 may request to the memory device 150 write and read operations through the FTL.

The FTL may manage operations of address mapping, garbage collection, wear-leveling, and so forth. Particularly, the FTL may store map data. Therefore, the controller 130 may map a logical address, which is provided from the host 102, to a physical address of the memory device 150 through the map data. The memory device 150 may perform an operation like a general device because of the address mapping operation. Also, through the address mapping operation based on the map data, when the controller 130 updates data of a particular page, the controller 130 may program new data into another empty page and may invalidate old data of the particular page due to a characteristic of a flash memory device. Further, the controller 130 may store map data of the new data into the FTL.

The processor 134 may be implemented with a microprocessor or a central processing unit (CPU). The memory system 110 may include one or more processors 134.

A management unit (not shown) may be included in the processor 134, and may perform bad block management of the memory device 150. The management unit may find bad memory blocks included in the memory device 150, which are in unsatisfactory condition for further use, and perform bad block management on the bad memory blocks. When the memory device 150 is a flash memory such as a NAND flash memory, a program failure may occur during the write operation (i.e., during the program operation), due to characteristics of a NAND logic function. During the bad block management, the data of the program-failed memory block or the bad memory block may be programmed into a new memory block. Also, the bad blocks due to the program fail seriously deteriorates the utilization efficiency of the memory device 150 having a 3D stack structure and the reliability of the memory system 100, and thus reliable bad block management is needed.

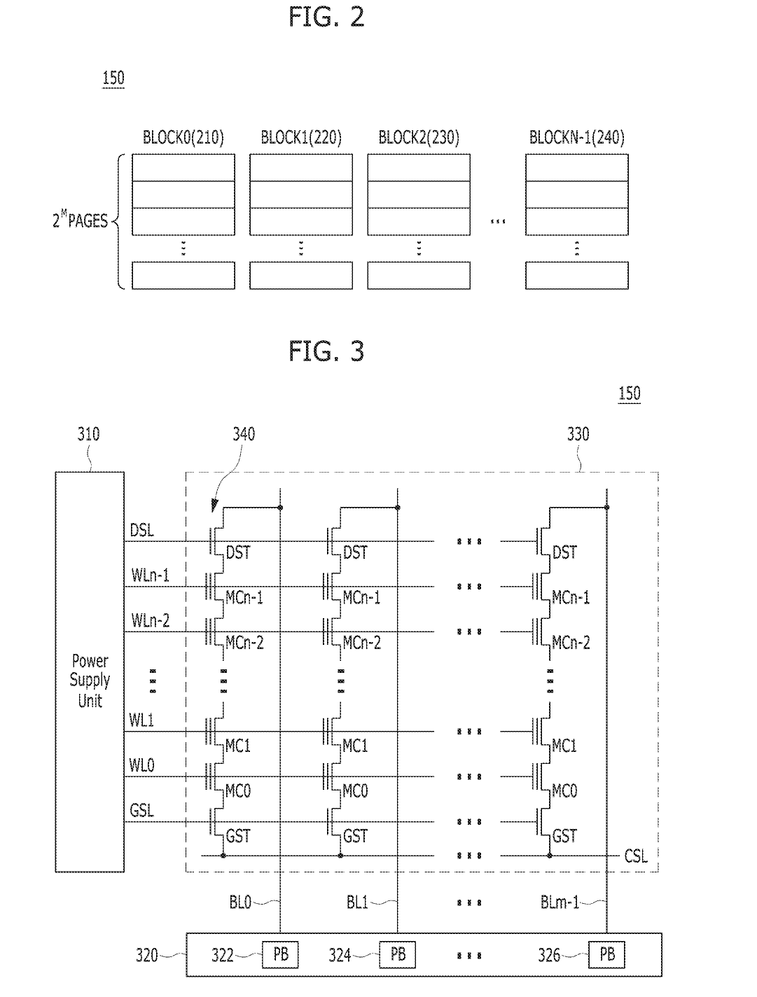

FIG. 2 is a schematic diagram illustrating the memory device 150 of FIG. 1.

Referring to FIG. 2, the memory device 150 may include the plurality of memory blocks BLOCK 0 to BLOCKN-1, and each of the blocks BLOCK 0 to BLOCKN-1 may include a plurality of pages, for example, 2^{M} pages, the number of which may vary according to circuit design. The memory device 150 may include a plurality of memory blocks, as single level cell (SLC) memory blocks and multi-level cell (MLC) memory blocks, according to the number of bits which may be stored or expressed in each memory cell. The SLC memory block may include a plurality of pages which are implemented with memory cells each capable of storing 1-bit data. The MLC memory block may include a plurality of pages which are implemented with memory cells each capable of storing multi-bit data, for example, two or more-bit data. An MLC memory block including a plurality of pages which are implemented with memory cells that are each capable of storing 3-bit data may be defined as a triple level cell (TLC) memory block.

Each of the plurality of memory blocks 210 to 240 may store the data provided from the host device 102 during a write operation, and may provide stored data to the host 102 during a read operation.

FIG. 3 is a circuit diagram illustrating a memory block 330 in the memory device 150 of FIGS. 1 and 2.

Referring to FIG. 3, the memory block 330 may correspond to any of the plurality of memory blocks 152 to 156 shown in FIG. 1.

Referring to FIG. 3, the memory block 330 of the memory device 150 may include a plurality of cell strings 340 which are electrically coupled to bit lines BL0 to BLm-1, respectively. The cell string 340 of each column may include at least one drain select transistor DST and at least one source select transistor SST. A plurality of memory cells or a plurality of memory cell transistors MC0 to MCn-1 may be electrically coupled in series between the select transistors DST and SST. The respective memory cells MC0 to MCn-1 may be configured by single level cells (SLC) each of which may store 1 bit of information, or by multi-level cells (MLC) each of which may store data information of a plurality of bits. The strings 340 may be electrically coupled to the corresponding bit lines BL0 to BLm-1, respectively. For reference, in FIG. 3, ‘DSL’ denotes a drain select line, ‘SSL’ denotes a source select line, and ‘CSL’ denotes a common source line.

While FIG. 3 only shows, as an example, the memory block 330 which is configured by NAND flash memory cells, it is to be noted that the memory block 330 of the memory device 150 according to the embodiment is not limited to NAND flash memory and may be realized by NOR flash memory, hybrid flash memory in which at least two kinds of memory cells are combined, or one-NAND flash memory in which a controller is built in a memory chip. The operational characteristics of a semiconductor device may be applied to not only a flash memory device in which a charge storing layer is configured by conductive floating gates but also a charge trap flash (CTF) in which a charge storing layer is configured by a dielectric layer.

A power supply unit 310 of the memory device 150 may provide word line voltages, for example, a program voltage, a read voltage and a pass voltage, to be supplied to respective word lines according to an operation mode and voltages to be supplied to bulks, for example, well regions in which the memory cells are formed. The power supply unit 310 may perform a voltage generating operation under the control of a control circuit (not shown). The power supply unit 310 may generate a plurality of variable read voltages to generate a plurality of read data, select one of the memory blocks or sectors of a memory cell array under the control of the control circuit, select one of the word lines of the selected memory block, and provide the word line voltages to the selected word line and unselected word lines.

A read/write circuit 320 of the memory device 150 may be controlled by the control circuit, and may serve as a sense amplifier or a write driver according to an operation mode. During a verification/normal read operation, the read/write circuit 320 may operate as a sense amplifier for reading data from the memory cell array. During a program operation, the read/write circuit 320 may operate as a write driver for driving bit lines according to data to be stored in the memory cell array. During a program operation, the read/write circuit 320 may receive from a buffer (not illustrated) data to be stored into the memory cell array, and drive bit lines according to the received data. The read/write circuit 320 may include a plurality of page buffers 322 to 326 respectively corresponding to columns (or bit lines) or column pairs (or bit line pairs), and each of the page buffers 322 to 326 may include a plurality of latches (not illustrated).

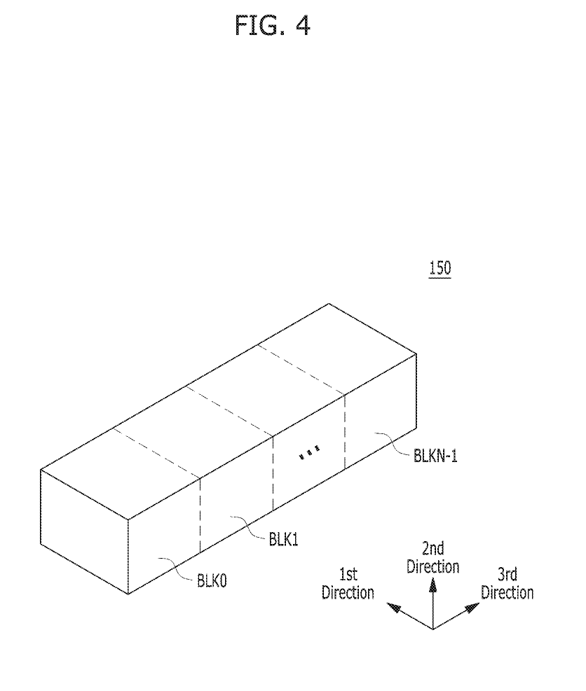

FIG. 4 is a schematic diagram illustrating a three-dimensional (3D) structure of the memory device 150 of FIGS. 1 and 2.

The memory device 150 may be embodied by a two-dimensional (2D) or a three-dimensional (3D) memory device. Specifically, as illustrated in FIG. 4, the memory device 150 may be embodied by a nonvolatile memory device having a 3D stack structure. When the memory device 150 has a 3D structure, the memory device 150 may include a plurality of memory blocks BLK0 to BLKN-1 each having a 3D structure (or vertical structure).

When there occurs an uncorrectable ECC (UECC) in a page storing data to be read during a read operation to the page, a controller may perform an error correction operation for recovering the programmed data. In general, a controller can perform an error correction operation by adjusting a read bias voltage and repeatedly reading data programmed in a memory device. However, a page may be determined as an UECC when a successful result is not output despite the repeated adjustment of the read bias voltage. As such, it may take a great deal of time to perform an error correction operation.

In the similar manner, when there are a great number of UECC pages in a memory block of a memory device due to an environmental factors such as a sudden power off (SPO) and so forth, a controller first determines whether a target page is an UECC or not in order to read data from an UECC page. Therefore, it may take a great amount of time for the controller to determine whether a target page is an UECC. Further, when there are a great number of UECC pages, it may take additional amount of time for the controller to determine whether a target page is an UECC, which may cause performance degradation of a whole system.

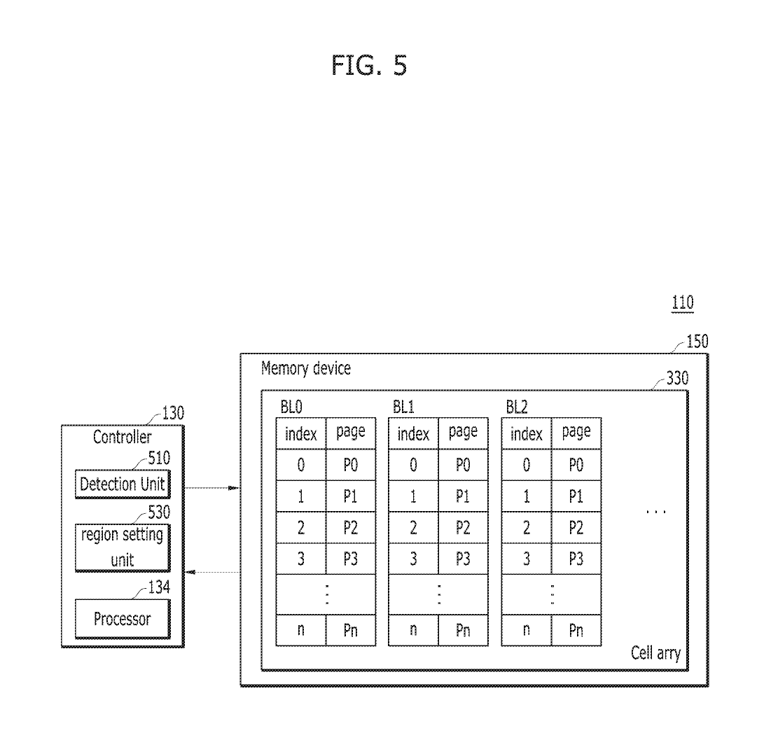

In accordance with an embodiment of the present invention, it is provided with a method of avoiding reading of an UECC page. In accordance with an embodiment of the present invention, the memory system 110 may skip a read operation to an unnecessary page. Described hereinafter with reference to FIGS. 5 to 7 will be the memory system 110 in accordance with an embodiment of the present invention.

FIG. 5 is a schematic diagram illustrating an exemplary configuration of the memory system 110, in accordance with an embodiment of the present invention. FIG. 5 schematically shows the controller 130 and the memory device 150, in accordance with an embodiment of the present invention.

The memory device 150 described with reference to FIG. 1 may include a memory cell array 330. The memory cell array 330 may include a plurality of memory blocks, e.g., BL0, BL1 and BL2. Each of the plurality of memory blocks may include a plurality of pages PO to Pn, each of which may be sequentially allocated with an index.

The memory controller 130 described with reference to FIG. 1 may include the processor 134, a detection unit 510 and a region setting unit 530.

As described with reference to FIG. 1, the processor 134 may control the memory device 150 to perform a read or program operation in response to a read or program command provided from the host 102. Also, the processor 134 may control the memory device 150 to perform a flush operation of flushing map data into the memory device 150 by units of map segments at each predetermined period. For example, after completion of a program operation writing data into three (3) pages, the processor 134 may control the memory device 150 to perform a flush operation to flush map data corresponding to the data of the performed operation into the memory device. More specifically, the processor 134 may control the memory device 150 to perform a program operation of storing data into three pages, for example, page 0 P0, page 1 P1 and page 2 P2 in response to a program command provided from the host 102, and then the processor 134 may control the memory device 150 to perform a flush operation of flushing map data corresponding to the data into a page 3 P3. Further, the processor 134 may control the memory device 150 to periodically perform a flush operation of flushing map data according to a process cycle as described above. However, when an SPO occurs while a process cycle is in progress, the cycle may start again from the beginning upon rebooting of the memory device. For example, continuing in the example mentioned above, an SPO may occur after completion of a program operation to only 2 of the three pages, while the processor 134 controls the memory device 150 to perform a flush operation of flushing map data after completion of a program operation to 3 pages, then the processor 134 may control again the memory device 150 to perform a flush operation of flushing map data after completion of a program operation to 3 pages. The processor 134 may manage a plurality of pages, which are storing data corresponding to map data before a flush operation of flushing the map data is performed, as a single page group. Although not illustrated, the processor 134 may control the memory device 150 to perform a flush operation of flushing map data into a meta-region among a plurality of memory blocks.

The detection unit 510 may detect an index corresponding to a page, to which an abnormal program operation occurs. For example, when an SPO occurs while the memory device 150 is performing a program operation of storing data into a page 2 P2 of a memory block 0 BL0, the detection unit 510 may detect the index representing the page, in which an SPO occurs, that is, the index of ‘2’ corresponding to the page 2 of the memory block 0 BL0. The detected index may be flushed along with map data. In an embodiment, a single index may represent a single memory block. In an embodiment, a single index may represent a single super memory block. In another embodiment, a single index may represent a single memory block. In another embodiment, a single index may represent a single super memory block. That is, the detection unit 510 may detect an index corresponding to a block or a super-block, to which an abnormal program operation occurs.

The region setting unit 530 may set a valid page region based on the detected index by units of memory blocks. During an error correction operation, the region setting unit 530 may set the valid page region based on the detected index. In the above example, when an SPO occurs while the memory device 150 is performing a program operation of storing data into the page 2 P2 of the memory block 0 BLO, the region setting unit 530 may set a page 0 P0 and a page 1 P1, which are previous to the page 2 P2, as the valid page region. On the other hand, the region setting unit 530 may set remaining page 2 P2 to a page n Pn other than the valid page region as an UECC page region. The region setting unit 530 may set the valid page region only for data corresponding to flushed map data.

In accordance with an embodiment of the present invention, the processor 134 may avoid a read operation of reading data programmed in an UECC page, which is set based on the index. The processor 134 may control the memory device 150 to perform a read operation of reading data programmed only in valid pages. While moving data stored in a closed memory block into a free memory block during a read reclaim operation, a garbage collection operation and so forth, the processor 134 may control the memory device 150 to perform a read operation of not reading data from an unnecessary UECC page but reading data only from valid pages.

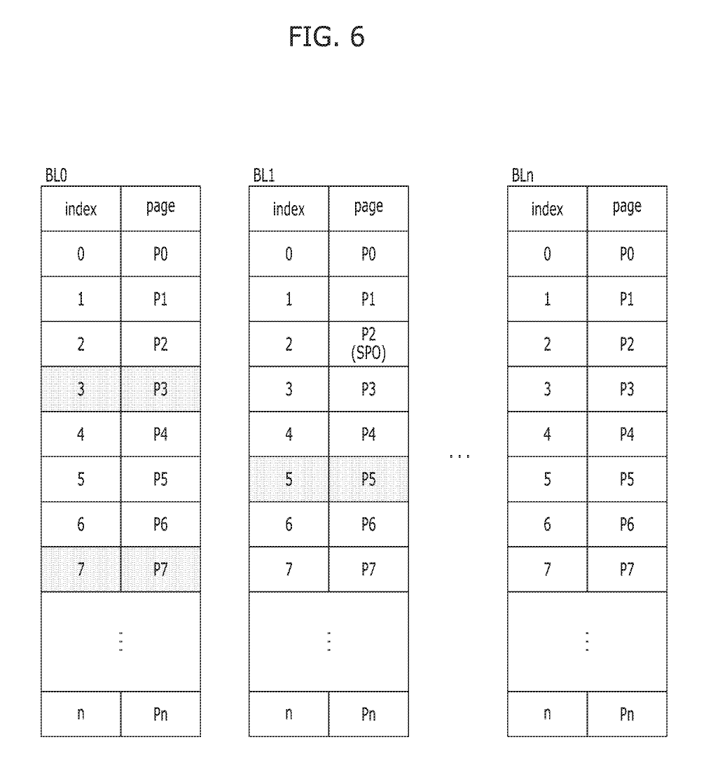

FIG. 6 is a schematic diagram illustrating a memory block according to an operation of the memory system 110 in accordance with an embodiment of the present invention. Hereinafter, for convenience of the description, it is assumed that the processor 134 controls the memory device 150 to perform a program operation of sequentially storing data into the pages of memory blocks 0 BL0 to BLn. Specifically, the processor 134 may sequentially store data into the pages P0 to Pn in the memory block 0 BL0, then into the pages P0 to Pn of the memory block 1 BL1 and so on and so forth into the remaining blocks. It is noted that this way of storing data sequentially at a block level and page level is a mere example and is not intended to limit the scope of the present invention.

Referring to FIG. 6, the processor 134 may also control the memory device 150 to flush map data corresponding to programmed data periodically at a predetermined period. For example, after completion of a program operation of storing the data into 3 pages, the processor 134 may control the memory device 150 to flush map data corresponding to the programmed data. For example, the processor 134 may control the memory device 150 to perform a program operation of storing data into the page 0 P0 to the page 2 P2 of the memory block 0 BL0, and then the processor 134 may control the memory device 150 to perform a flush operation of flushing map data corresponding to the programmed data into the page 3 P3 of the memory block 0 BL0. As long as the cycle is maintained, the processor 134 may control the memory device 150 to perform a program operation of storing data into the page 4 P4 to the page 6 P6 of the memory block 0 BL0, and then the processor 134 may control the memory device 150 to perform a flush operation of flushing map data corresponding to the programmed data into the page 7 P7 of the memory block 0 BL0.

However, when an SPO occurs while such cycle is in progress, the process cycle of storing the data which was interrupted (e.g., the process of storing data in three pages at a time) may start again from the beginning at the page, in which the SPO occurred. For example, the processor 134 may control the memory device 150 to perform a flush operation of flushing map data corresponding to the data, which is programmed into the page 0 P0 to the page 2 P2 of the memory block 1 BL1, into the page 3 P3 of the memory block 1 BL1 when it is assumed that the processor 134 controls the memory device 150 to perform a flush operation of flushing map data after completion of a program operation to 3 pages. However, when an SPO occurs during a program operation to the page 2 P2 of the memory block 1 BL1, the processor 134 may control again the memory device 150 to perform a flush operation of flushing map data corresponding to the data, which is programmed into the page 0 P0 to a page 4 P4 of the memory block 1 BL1, into a page 5 P5 of the memory block 1 BL1 since the cycle starts again from the beginning at the page 2 P2 of the memory block 1 BL1. Here, the detection unit 510 may detect the occurrence of the SPO in the page 2 P2 of the memory block 1 BL1, and the processor 134 may control the memory device 150 to perform a flush operation of flushing the index of ‘2’, which represents the page 2 of the memory block 1 BL1, as well as the map data corresponding to the data, which is programmed into the page 0 P0 to a page 4 P4 of the memory block 1 BL1, into the page 5 P5 of the memory block 1 BL1.

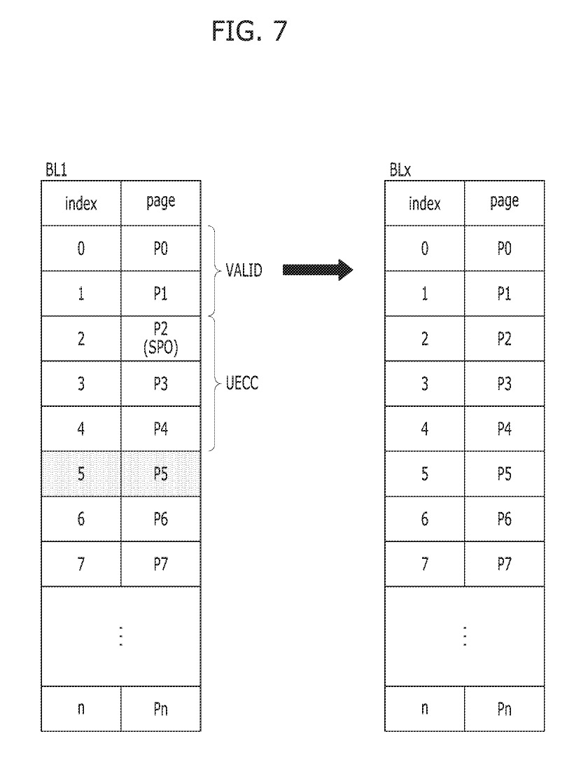

FIG. 7 is a schematic diagram illustrating a memory block according to an operation of the memory system 110 in accordance with an embodiment of the present invention. FIG. 7 shows a memory block according to an operation of the memory system 110 when data stored in an open block or a closed block is moved into a free block during an operation such as a read reclaim operation, a garbage collection operation and so forth.

Referring to FIG. 7, the detection unit 510 may detect that an SPO occurs while data is being programmed into the page 2 P2 of the memory block 1 BL1, and the index of ‘2’ representing the page 2 P2 of the memory block 1 BL1 may be stored in the page 5 P5 of the memory block 1 BL1.

Then, when an operation (e.g., a read reclaim operation or a garbage collection operation) of moving data is performed, the region setting unit 530 may set a valid page region based on the detected index. For example, since an SPO occurs while data is being programmed into the page 2 P2 of the memory block 1 BL1, the region setting unit 530 may determine the page 2 P2 of the memory block 1 BL1 as an UECC page region. Further, the region setting unit 530 may determine the page 3 P3 and the page 4 P4 of the memory block 1 BL1, into which data is programmed after the occurrence of the SPO, as UECC pages. That is, the region setting unit 530 may set the page 2 P2 to the page 4 P4 of the memory block 1 BL1 as an UECC page region. On the other hand, the region setting unit 530 may set the page 0 P0 and the page 1 P1 of the memory block 1 BL1 as a valid page region.

The processor 134 may control the memory device 150 to perform a read reclaim operation of a garbage collection operation based on the set regions. The processor 134 may control the memory device 150 to copy data of the page 0 P0 and the page 1 P1 (i.e., the valid pages) of the memory block 1 BL1 into a free memory block BLx, and may control the memory device 150 not to perform a read operation of reading data from the page 2 P2 to the page 4 P4 of the memory block BL1. The processor 134 may control the memory device 150 to avoid a read operation to the UECC page region based on the set regions.

As described above, in accordance with an embodiment of the present invention, a page to which an abnormal program operation is performed due to an external situation, and at least one subsequent page into which data is programmed after the abnormal program operation may be determined as UECC pages. Further, in accordance with an embodiment of the present invention, a read operation may be avoided to the UECC pages. Therefore, in accordance with an embodiment of the present invention, the memory system 110 may skip a determination operation and a read operation during a read reclaim operation, a garbage collection operation and so forth, thereby improving performance thereof.

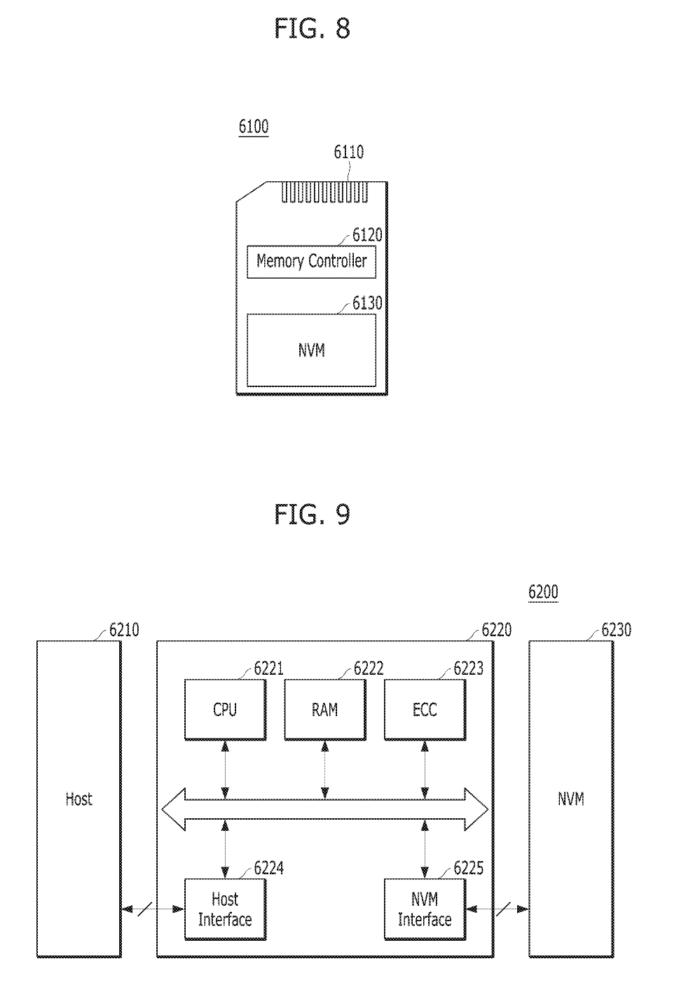

FIGS. 8 to 16 are diagrams schematically illustrating application examples of the data processing system of FIGS. 1 to 7 according to various embodiments.

FIG. 8 is a diagram schematically illustrating an example of the data processing system including the memory system in accordance with the present embodiment. FIG. 8 schematically illustrates a memory card system to which the memory system in accordance with the present embodiment is applied.

Referring to FIG. 8, the memory card system 6100 may include a memory controller 6120, a memory device 6130, and a connector 6110.

More specifically, the memory controller 6120 may be connected to the memory device 6130 embodied by a nonvolatile memory, and configured to access the memory device 6130. For example, the memory controller 6120 may be configured to control read, write, erase and background operations of the memory device 6130. The memory controller 6120 may be configured to provide an interface between the memory device 6130 and a host, and drive firmware for controlling the memory device 6130. That is, the memory controller 6120 may correspond to the controller 130 of the memory system 110 described with reference to FIGS. 1 to 7, and the memory device 6130 may correspond to the memory device 150 of the memory system 110 described with reference to FIGS. 1 to 7.

Thus, the memory controller 6120 may include a RAM, a processing unit, a host interface, a memory interface and an error correction unit. The memory controller 130 may further include the elements described in FIG. 1.

The memory controller 6120 may communicate with an external device, for example, the host 102 of FIG. 1 through the connector 6110. For example, as described with reference to FIG. 1, the memory controller 6120 may be configured to communicate with an external device through one or more of various communication protocols such as universal serial bus (USB), multimedia card (MMC), embedded MMC (eMMC), peripheral component interconnection (PCI), PCI express (PCIe), Advanced Technology Attachment (ATA), Serial-ATA, Parallel-ATA, small computer system interface (SCSI), enhanced small disk interface (EDSI), Integrated Drive Electronics (IDE), Firewire, universal flash storage (UFS), WIFI and Bluetooth. Thus, the memory system and the data processing system in accordance with the present embodiment may be applied to wired/wireless electronic devices or particularly mobile electronic devices.

The memory device 6130 may be implemented by a nonvolatile memory. For example, the memory device 6130 may be implemented by various nonvolatile memory devices such as an erasable and programmable ROM (EPROM), an electrically erasable and programmable ROM (EEPROM), a NAND flash memory, a NOR flash memory, a phase-change RAM (PRAM), a resistive RAM (ReRAM), a ferroelectric RAM (FRAM) and a spin torque transfer magnetic RAM (STT-RAM). The memory device 6130 may include a plurality of dies as in the memory device 150 of FIG. 1.

The memory controller 6120 and the memory device 6130 may be integrated into a single semiconductor device. For example, the memory controller 6120 and the memory device 6130 may construct a solid state driver (SSD) by being integrated into a single semiconductor device. Also, the memory controller 6120 and the memory device 6130 may construct a memory card such as a PC card (PCMCIA: Personal Computer Memory Card International Association), a compact flash (CF) card, a smart media card (e.g., SM and SMC), a memory stick, a multimedia card (e.g., MMC, RS-MMC, MMCmicro and eMMC), an SD card (e.g., SD, miniSD, microSD and SDHC) and a universal flash storage (UFS).

FIG. 9 is a diagram schematically illustrating an example of the data processing system including a memory system, in accordance with the present embodiment.

Referring to FIG. 9, the data processing system 6200 may include a memory device 6230 having one or more nonvolatile memories and a memory controller 6220 for controlling the memory device 6230. The data processing system 6200 illustrated in FIG. 9 may serve as a storage medium such as a memory card (CF, SD, micro-SD or the like) or USB device, as described with reference to FIG. 1.

The memory device 6230 may correspond to the memory device 150 in the memory system 110 described in FIGS. 1 to 7, and the memory controller 6220 may correspond to the controller 130 in the memory system 110 described in FIGS. 1 to 7.

The memory controller 6220 may control a read, write or erase operation on the memory device 6230 in response to a request of the host 6210, and the memory controller 6220 may include one or more CPUs 6221, a buffer memory such as RAM 6222, an ECC circuit 6223, a host interface 6224 and a memory interface such as an NVM interface 6225.

The CPU 6221 may control the operations on the memory device 6230, for example, read, write, file system management and bad page management operations. The RAM 6222 may be operated according to control of the CPU 6221, and used as a work memory, buffer memory or cache memory. When the RAM 6222 is used as a work memory, data processed by the CPU 6221 may be temporarily stored in the RAM 6222. When the RAM 6222 is used as a buffer memory, the RAM 6222 may be used for buffering data transmitted to the memory device 6230 from the host 6210 or transmitted to the host 6210 from the memory device 6230. When the RAM 6222 is used as a cache memory, the RAM 6222 may assist the low-speed memory device 6230 to operate at high speed.

The ECC circuit 6223 may correspond to the ECC unit 138 of the controller 130 illustrated in FIG. 1. As described with reference to FIG. 1, the ECC circuit 6223 may generate an CC (Error Correction Code) for correcting a fail bit or error bit of data provided from the memory device 6230. The ECC circuit 6223 may perform error correction encoding on data provided to the memory device 6230, thereby forming data with a parity bit. The parity bit may be stored in the memory device 6230. The ECC circuit 6223 may perform error correction decoding on data outputted from the memory device 6230. At this time, the ECC circuit 6223 may correct an error using the parity bit. For example, as described with reference to FIG. 1, the ECC circuit 6223 may correct an error using the LDPC code, BCH code, turbo code, Reed-Solomon code, convolution code, RSC or coded modulation such as TCM or BCM.

The memory controller 6220 may transmit/receive data to/from the host 6210 through the host interface 6224, and transmit/receive data to/from the memory device 6230 through the NVM interface 6225. The host interface 6224 may be connected to the host 6210 through a PATA bus, SATA bus, SCSI, USB, PCIe or NAND interface. The memory controller 6220 may have a wireless communication function with a mobile communication protocol such as WiFi or Long Term Evolution (LTE). The memory controller 6220 may be connected to an external device, for example, the host 6210 or another external device, and then transmit/receive data to/from the external device. In particular, as the memory controller 6220 is configured to communicate with the external device through one or more of various communication protocols, the memory system and the data processing system in accordance with the present embodiment may be applied to wired/wireless electronic devices or particularly a mobile electronic device.

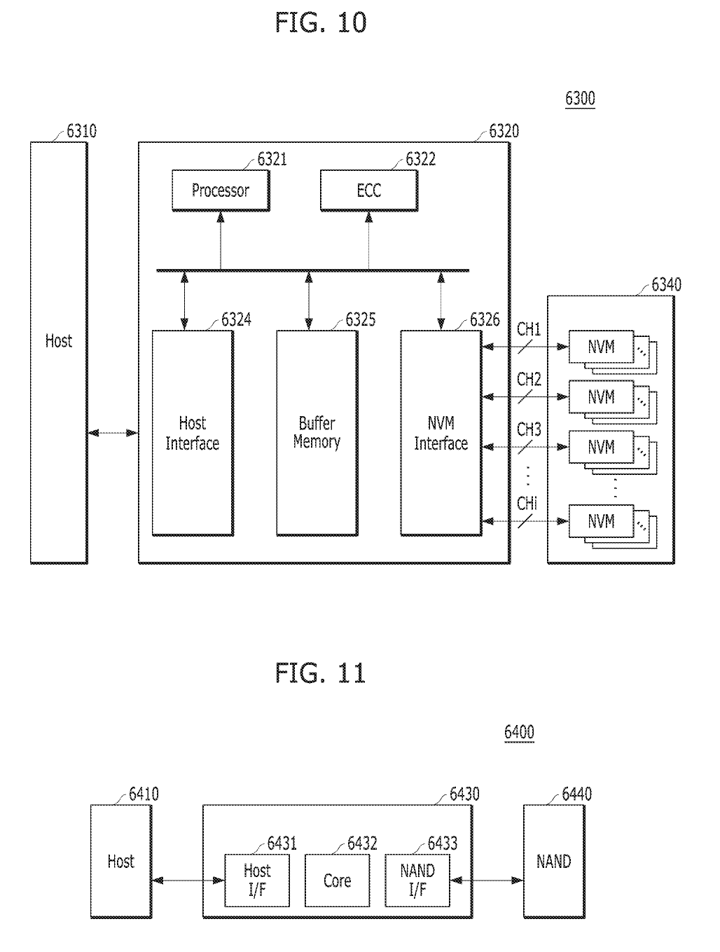

FIG. 10 is a diagram schematically illustrating an example of the data processing system including the memory system in accordance with the present embodiment. FIG. 10 schematically illustrates an SSD to which the memory system in accordance with the present embodiment is applied.

Referring to FIG. 10, the SSD 6300 may include a controller 6320 and a memory device 6340 including a plurality of nonvolatile memories. The controller 6320 may correspond to the controller 130 in the memory system 110 of FIG. 1, and the memory device 6340 may correspond to the memory device 150 in the memory system of FIG. 1.

More specifically, the controller 6320 may be connected to the memory device 6340 through a plurality of channels CH1 to CHi. The controller 6320 may include one or more processors 6321, a buffer memory 6325, an ECC circuit 6322, a host interface 6324 and a memory interface, for example, a nonvolatile memory interface 6326.

The buffer memory 6325 may temporarily store data provided from the host 6310 or data provided from a plurality of flash memories NVM included in the memory device 6340, or temporarily store meta data of the plurality of flash memories NVM, for example, map data including a mapping table. The buffer memory 6325 may be embodied by volatile memories such as DRAM, SDRAM, DDR SDRAM, LPDDR SDRAM and GRAM or nonvolatile memories such as FRAM, ReRAM, STT-MRAM and PRAM. For convenience of description, FIG. 10 illustrates that the buffer memory 6325 exists in the controller 6320. However, the buffer memory 6325 may exist outside the controller 6320.

The ECC circuit 6322 may calculate an ECC value of data to be programmed to the memory device 6340 during a program operation, perform an error correction operation on data read from the memory device 6340 based on the ECC value during a read operation, and perform an error correction operation on data recovered from the memory device 6340 during a failed data recovery operation.

The host interface 6324 may provide an interface function with an external device, for example, the host 6310, and the nonvolatile memory interface 6326 may provide an interface function with the memory device 6340 connected through the plurality of channels.

Furthermore, a plurality of SSDs 6300 to which the memory system 110 of FIG. 1 is applied may be provided to embody a data processing system, for example, RAID (Redundant Array of Independent Disks) system. At this time, the RAID system may include the plurality of SSDs 6300 and a RAID controller for controlling the plurality of SSDs 6300. When the RAID controller performs a program operation in response to a write command provided from the host 6310, the RAID controller may select one or more memory systems or SSDs 6300 according to a plurality of RAID levels, that is, RAID level information of the write command provided from the host 6310 in the SSDs 6300, and output data corresponding to the write command to the selected SSDs 6300. Furthermore, when the RAID controller performs a read command in response to a read command provided from the host 6310, the RAID controller may select one or more memory systems or SSDs 6300 according to a plurality of RAID levels, that is, RAID level information of the read command provided from the host 6310 in the SSDs 6300, and provide data read from the selected SSDs 6300 to the host 6310.

FIG. 11 is a diagram schematically illustrating an example of the data processing system including the memory system in accordance with an embodiment. FIG. 11 schematically illustrates an embedded Multi-Media Card (eMMC) to which the memory system in accordance with an embodiment is applied.

Referring to FIG. 11, the eMMC 6400 may include a controller 6430 and a memory device 6440 embodied by one or more NAND flash memories. The controller 6430 may correspond to the controller 130 in the memory system 110 of FIG. 1, and the memory device 6440 may correspond to the memory device 150 in the memory system 110 of FIG. 1.

More specifically, the controller 6430 may be connected to the memory device 6440 through a plurality of channels. The controller 6430 may include one or more cores 6432, a host interface 6431 and a memory interface, for example, a NAND interface 6433.

The core 6432 may control the operations of the eMMC 6400, the host interface 6431 may provide an interface function between the controller 6430 and the host 6410, and the NAND interface 6433 may provide an interface function between the memory device 6440 and the controller 6430. For example, the host interface 6431 may serve as a parallel interface, for example, MMC interface as described with reference to FIG. 1. Furthermore, the host interface 6431 may serve as a serial interface, for example, UHS ((Ultra High Speed)-I/UHS-II) interface.

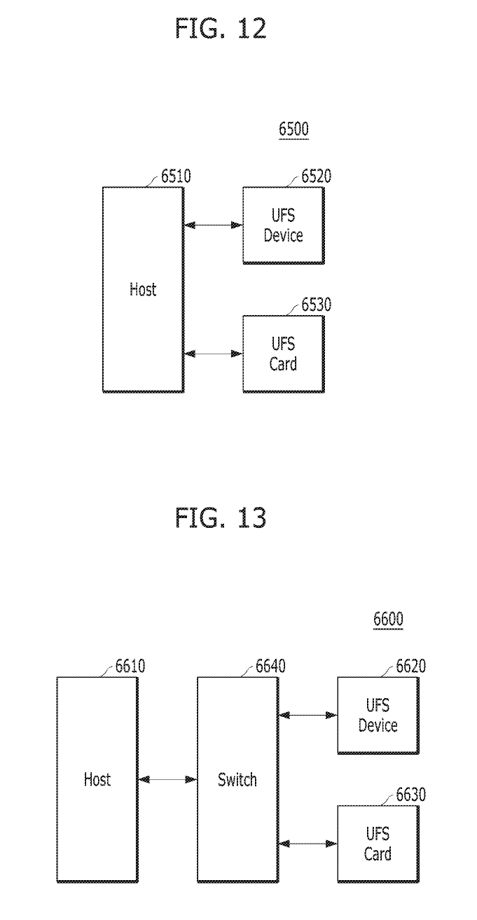

FIGS. 12 to 15 are diagrams schematically illustrating other examples of the data processing system including the memory system in accordance with an embodiment. FIGS. 12 to 15 schematically illustrate UFS (Universal Flash Storage) systems to which the memory system in accordance with an embodiment is applied.

Referring to FIGS. 12 to 15, the UFS systems 6500, 6600, 6700 and 6800 may include hosts 6510, 6610, 6710 and 6810, UFS devices 6520, 6620, 6720 and 6820 and UFS cards 6530, 6630, 6730 and 6830, respectively. The hosts 6510, 6610, 6710 and 6810 may serve as application processors of wired/wireless electronic devices or particularly mobile electronic devices, the UFS devices 6520, 6620, 6720 and 6820 may serve as embedded UFS devices, and the UFS cards 6530, 6630, 6730 and 6830 may serve as external embedded UFS devices or removable UFS cards.

The hosts 6510, 6610, 6710 and 6810, the UFS devices 6520, 6620, 6720 and 6820 and the UFS cards 6530, 6630, 6730 and 6830 in the respective UFS systems 6500, 6600, 6700 and 6800 may communicate with external devices, for example, wired/wireless electronic devices or particularly mobile electronic devices through UFS protocols, and the UFS devices 6520, 6620, 6720 and 6820 and the UFS cards 6530, 6630, 6730 and 6830 may be embodied by the memory system 110 illustrated in FIG. 1. For example, in the UFS systems 6500, 6600, 6700 and 6800, the UFS devices 6520, 6620, 6720 and 6820 may be embodied in the form of the data processing system 6200, the SSD 6300 or the eMMC 6400 described with reference to FIGS. 9 to 11, and the UFS cards 6530, 6630, 6730 and 6830 may be embodied in the form of the memory card system 6100 described with reference to FIG. 8.

Furthermore, in the UFS systems 6500, 6600, 6700 and 6800, the hosts 6510, 6610, 6710 and 6810, the UFS devices 6520, 6620, 6720 and 6820 and the UFS cards 6530, 6630, 6730 and 6830 may communicate with each other through an UFS interface, for example, MIPI M-PHY and MIPI UniPro (Unified Protocol) in MIPI (Mobile Industry Processor Interface). Furthermore, the UFS devices 6520, 6620, 6720 and 6820 and the UFS cards 6530, 6630, 6730 and 6830 may communicate with each other through various protocols other than the UFS protocol, for example, UFDs, MMC, SD, mini-SD, and micro-SD.

In the UFS system 6500 illustrated in FIG. 12, each of the host 6510, the UFS device 6520 and the UFS card 6530 may include UniPro. The host 6510 may perform a switching operation in order to communicate with the UFS device 6520 and the UFS card 6530. In particular, the host 6510 may communicate with the UFS device 6520 or the UFS card 6530 through link layer switching, for example, L3 switching at the UniPro. At this time, the UFS device 6520 and the UFS card 6530 may communicate with each other through link layer switching at the UniPro of the host 6510. In the present embodiment, the configuration in which one UFS device 6520 and one UFS card 6530 are connected to the host 6510 has been exemplified for convenience of description. However, a plurality of UFS devices and UFS cards may be connected in parallel or in the form of a star to the host 6410, and a plurality of UFS cards may be connected in parallel or in the form of a star to the UFS device 6520 or connected in series or in the form of a chain to the UFS device 6520.

In the UFS system 6600 illustrated in FIG. 13, each of the host 6610, the UFS device 6620 and the UFS card 6630 may include UniPro, and the host 6610 may communicate with the UFS device 6620 or the UFS card 6630 through a switching module 6640 performing a switching operation, for example, through the switching module 6640 which performs link layer switching at the UniPro, for example, L3 switching. The UFS device 6620 and the UFS card 6630 may communicate with each other through link layer switching of the switching module 6640 at UniPro. In the present embodiment, the configuration in which one UFS device 6620 and one UFS card 6630 are connected to the switching module 6640 has been exemplified for convenience of description. However, a plurality of UFS devices and UFS cards may be connected in parallel or in the form of a star to the switching module 6640, and a plurality of UFS cards may be connected in series or in the form of a chain to the UFS device 6620.

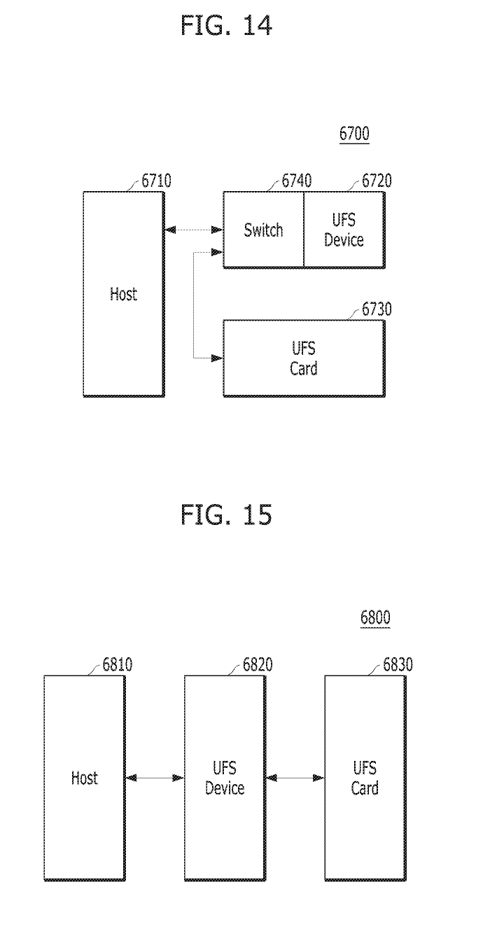

In the UFS system 6700 illustrated in FIG. 14, each of the host 6710, the UFS device 6720 and the UFS card 6730 may include UniPro, and the host 6710 may communicate with the UFS device 6720 or the UFS card 6730 through a switching module 6740 performing a switching operation, for example, through the switching module 6740 which performs link layer switching at the UniPro, for example, L3 switching. At this time, the UFS device 6720 and the UFS card 6730 may communicate with each other through link layer switching of the switching module 6740 at the UniPro, and the switching module 6740 may be integrated as one module with the UFS device 6720 inside or outside the UFS device 6720. In the present embodiment, the configuration in which one UFS device 6720 and one UFS card 6730 are connected to the switching module 6740 has been exemplified for convenience of description. However, a plurality of modules each including the switching module 6740 and the UFS device 6720 may be connected in parallel or in the form of a star to the host 6710 or connected in series or in the form of a chain to each other. Furthermore, a plurality of UFS cards may be connected in parallel or in the form of a star to the UFS device 6720.

In the UFS system 6800 illustrated in FIG. 15, each of the host 6810, the UFS device 6820 and the UFS card 6830 may include M-PHY and UniPro. The UFS device 6820 may perform a switching operation in order to communicate with the host 6810 and the UFS card 6830. In particular, the UFS device 6820 may communicate with the host 6810 or the UFS card 6830 through a switching operation between the M-PHY and UniPro module for communication with the host 6810 and the M-PHY and UniPro module for communication with the UFS card 6830, for example, through a target ID (Identifier) switching operation. At this time, the host 6810 and the UFS card 6830 may communicate with each other through target ID switching between the M-PHY and UniPro modules of the UFS device 6820. In the present embodiment, the configuration in which one UFS device 6820 is connected to the host 6810 and one UFS card 6830 is connected to the UFS device 6820 has been exemplified for convenience of description. However, a plurality of UFS devices may be connected in parallel or in the form of a star to the host 6810, or connected in series or in the form of a chain to the host 6810, and a plurality of UFS cards may be connected in parallel or in the form of a star to the UFS device 6820, or connected in series or in the form of a chain to the UFS device 6820.

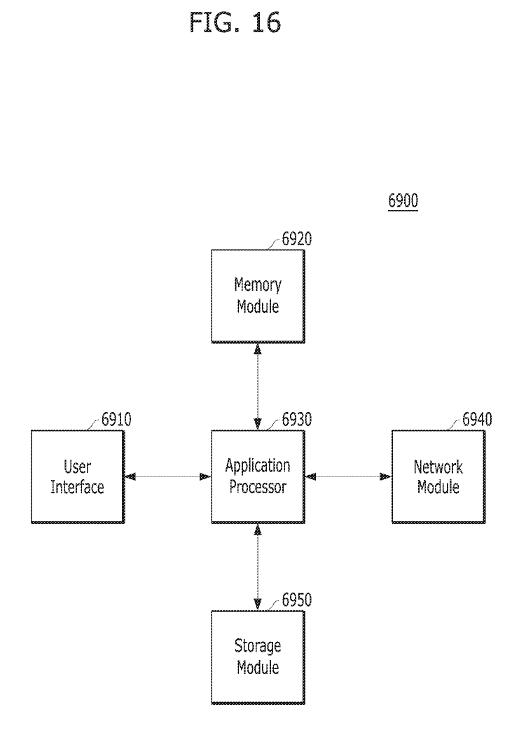

FIG. 16 is a diagram schematically illustrating another example of the data processing system including the memory system in accordance with an embodiment. FIG. 16 is a diagram schematically illustrating a user system to which the memory system in accordance with an embodiment is applied.

Referring to FIG. 16, the user system 6900 may include an application processor 6930, a memory module 6920, a network module 6940, a storage module 6950 and a user interface 6910.

More specifically, the application processor 6930 may drive components included in the user system 6900, for example, an OS, and include controllers, interfaces and a graphic engine which control the components included in the user system 6900. The application processor 6930 may be provided as a System-on-Chip (SoC).

The memory module 6920 may be used as a main memory, work memory, buffer memory or cache memory of the user system 6900. The memory module 6920 may include a volatile RAM such as DRAM, SDRAM, DDR SDRAM, DDR2 SDRAM, DDR3 SDRAM, LPDDR SDARM, LPDDR3 SDRAM or LPDDR3 SDRAM or a nonvolatile RAM such as PRAM, ReRAM, MRAM or FRAM. For example, the application processor 6930 and the memory module 6920 may be packaged and mounted, based on POP (Package on Package).

The network module 6940 may communicate with external devices. For example, the network module 6940 may not only support wired communication, but may also support various wireless communication protocols such as code division multiple access (CDMA), global system for mobile communication (GSM), wideband CDMA (WCDMA), CDMA-2000, time division multiple access (TDMA), long term evolution (LTE), worldwide interoperability for microwave access (Wimax), wireless local area network (WLAN), ultra-wideband (UWB), Bluetooth, wireless display (WI-DI), thereby communicating with wired/wireless electronic devices or particularly mobile electronic devices. Therefore, the memory system and the data processing system, in accordance with an embodiment of the present invention, can be applied to wired/wireless electronic devices. The network module 6940 may be included in the application processor 6930.

The storage module 6950 may store data, for example, data received from the application processor 6930, and then may transmit the stored data to the application processor 6930. The storage module 6950 may be embodied by a nonvolatile semiconductor memory device such as a phase-change RAM (PRAM), a magnetic RAM (MRAM), a resistive RAM (ReRAM), a NAND flash, NOR flash and 3D NAND flash, and provided as a removable storage medium such as a memory card or external drive of the user system 6900. The storage module 6950 may correspond to the memory system 110 described with reference to FIG. 1. Furthermore, the storage module 6950 may be embodied as an SSD, eMMC and UFS as described above with reference to FIGS. 10 to 15.

The user interface 6910 may include interfaces for inputting data or commands to the application processor 6930 or outputting data to an external device. For example, the user interface 6910 may include user input interfaces such as a keyboard, a keypad, a button, a touch panel, a touch screen, a touch pad, a touch ball, a camera, a microphone, a gyroscope sensor, a vibration sensor and a piezoelectric element, and user output interfaces such as a liquid crystal display (LCD), an organic light emitting diode (OLED) display device, an active matrix OLED (AMOLED) display device, an LED, a speaker and a motor.

Furthermore, when the memory system 110 of FIG. 1 is applied to a mobile electronic device of the user system 6900, the application processor 6930 may control the operations of the mobile electronic device, and the network module 6940 may serve as a communication module for controlling wired/wireless communication with an external device. The user interface 6910 may display data processed by the processor 6930 on a display/touch module of the mobile electronic device, or support a function of receiving data from the touch panel.

While the present invention has been described with respect to specific embodiments, it will be apparent to those skilled in the art that various changes and modifications may be made without departing from the spirit and scope of the invention as defined in the following claims.

What is claimed is:

1. A memory system comprising:
a memory device suitable for storing indexes corresponding to a plurality of pages included in at least one memory block;
a controller including:
a detection unit suitable for detecting an index corresponding to a page, to which an abnormal program operation is performed, in a page group;
a region setting unit suitable for setting a valid page region of the page group based on the detected index; and
a processor suitable for controlling the memory device to flush the index along with map data corresponding to data, which is stored in the page group, at each predetermined period,
wherein the page group includes a plurality of pages, in which data corresponding to the map data is stored until the map data is flushed.

2. The memory system of claim 1, wherein the region setting unit sets remaining pages other than the valid page region in the page group as an uncorrectable error correction code (UECC) page region.

3. The memory system of claim 2, wherein the processor controls the memory device to perform a read operation of reading data stored in the valid page region other than the UECC page region.

4. The memory system of claim 3, wherein the detection unit detects, when an SPO occurs, an index corresponding to a page, to which a program operation is being performed at the occurrence of the SPO.

5. The memory system of claim 4, wherein the processor controls the memory device to copy data stored in the valid page region into a free memory block based on the index.

6. The memory system of claim 3, wherein the processor controls the memory device to perform a garbage collection operation to the valid page region by referencing the index.

7. The memory system of claim 4, wherein the processor controls, after the occurrence of the SPO, the memory device to flush the map data along with the index according to the predetermined period, which is restarted.

8. An operating method of a memory system, the method comprising:
detecting an index corresponding to a page, to which an abnormal program operation is performed, in a page group of a memory device;
setting a valid page region of the page group based on the index; and
controlling the memory device to flush the index along with map data corresponding to data, which is stored in the page group, at each predetermined period,
wherein the indexes correspond to a plurality of pages included in each of memory blocks, and
wherein the page group includes a plurality of pages, in which data corresponding to the map data is stored until the map data is flushed.

9. The method of claim 8, further comprising setting remaining pages other than the valid page region in the page group as an UECC page region.

10. The method of claim 8, further comprising controlling the memory device to perform a read operation of reading data stored in the valid page region other than the UECC page region.

11. The method of claim 10, wherein the detecting of the index includes detecting, when an SPO occurs, an index corresponding to a page, to which a program operation is being performed at the occurrence of the SPO.

12. The method of claim 11, further comprising controlling the memory device to copy data stored in the valid page region into a free memory block based on the index.

13. The method of claim 10, further comprising controlling the memory device to perform a garbage collection operation to the valid page region by referencing the index.

14. The method of claim 11, further comprising controlling, after the occurrence of the SPO, the memory device to flush the map data along with the index according to the predetermined period, which is restarted.

15. A memory system comprising:
a memory device suitable for storing indexes corresponding to a plurality of pages included in each of a plurality of memory blocks; and
a controller suitable for controlling the memory device to flush map data corresponding to data which is stored in a page group periodically at a predetermined period,
a detection unit is suitable for detecting a page and an index for the page in the page group to which an abnormal program operation is performed; and
a region setting unit suitable for defining the page group into a valid page region and an uncorrectable error correction code UECC region based on the detected page index.

16. The memory system of claim 15, wherein the page group includes a plurality of pages in which data is stored which correspond to the flushed map data.

17. The memory system of claim 15, wherein the region setting unit sets remaining pages other than the valid page region in the page group as the UECC page region.

18. The memory system of claim 16, wherein the controller controls the memory device to perform a read operation of reading data stored in the valid page region other than the UECC page region.

19. The memory system of claim 15, wherein the abnormal operation is an SPO.

20. The memory system of claim 18, wherein the controller controls the memory device to copy data stored in the valid page region into a free memory block.
